(19) United States
(12) Patent Application Publication
(10) Pub. No.: US 2003/0235185 A1
(43) Pub. Date: Dec. 25, 2003

(54) Access mechanism assignment

(76) Inventors: Jonathan Gibbs, Jays Close Viables Industrial Estate (GB); Stephen Aftelak, Jays Close Industrial Estate Basingstoke (GB); Charlotte Baden, Jays Close Viables Industrial Estate (GB)

Correspondence Address: MOTOROLA, INC., 1303 EAST ALGONQUIN ROAD, IL01/3RD, SCHAUMBURG, IL, 60196

(21) Appl. No.: 10/343,344

(22) PCT Filed: Aug. 6, 2001
(86) PCT No.: PCT/EP01/09079

(30) Foreign Application Priority Data
Aug. 18, 2000 (GB) 0020303.4

(51) Int. Cl. H04L 12/66; H04J 3/16

(52) U.S. Cl. 370/352; 370/437

(57) ABSTRACT

A method of assigning an access mechanism for the transmission of data comprises classifying a plurality of components of the data and assigning these individually to a particular access mechanism according to the suitability of the access mechanism in relation to a particular parameter or set of parameters of the data component by which it is clasified.

This invention relates to assigning an access mechanism to data for transmission over a communications network.

On various communications networks it is possible to use different access mechanisms to encode and deliver different categories of information. An access mechanism is the means of connecting user apparatus (eg. a mobile telephone, fixed telephone, personal computer or other device requiring access through a communications system. For example, a typical fixed telephone in the home is hard wired to the local exchange. For a cellular telephone system the access mechanism is the air interface which includes the link (eg. radio) from/to the base station, the onward link from/to the base station controller or radio network controller, and the attendant procedures and protocols that enable transmission and reception.

An example of a communications network over which different categories of information can be sent is a Third Generation (3G) mobile network such as UMTS (the Universal Mobile Telecommunications System), or an enhanced Second Generation (2G) mobile network incorporating a General Packet Radio Service (GPRS). These are in general able to support speech (not using GPRS), music, video and text communications. The data is sent in blocks or packets and re-assembled and decoded at the receiver device. Typically, a multi-media service will involve data from some or all of these categories and additional data for on-line messaging. Each form of data has different requirements of the means by which it is encoded for transmission (or broadcast) from source or relay point to recipient(s).

To take the multi-media example, the priorities associated with the different data components differ. Video data may have a demanding requirement for both minimal delay in the transmitted data and a high bit rate. Voice and music (audio) information may place a high demand on delay to avoid impairing the quality of the perceived sound, but are less demanding on the bit rate. Text data is more tolerant of delays in the transmitted information as it can be buffered before being assembled at the recipient device, but it is more heavily dependent on the integrity of the access mechanism to transmit the data accurately. Thus, an access mechanism designed to optimise transmission for one class of data could cause a degradation in the quality of service when used in respect of another class or, conversely, be too wasteful of network capacity.

As well as the inherent (fixed) characteristics of an access mechanism, there may also be characteristics that change with time and/or changes in the environment in which the network access mechanism in used.

It is known in circuit switched communications systems, such as those covered by the ITU-T recommendations G.703, G.704 which use 64 kbit/sec time slotted pulse code modulated signalling, to pool slots for transmission of a given form of information. However, this only addresses access requirements in respect to the same access mechanism. It does not differentiate between disparate requirements of the forms of information to be sent.

It is an object of the present invention to address the differing requirements of different forms of information to be transmitted over a given network.

According to one embodiment of the present invention, there is provided a method of assigning an access mechanism to data to be transmitted between a sender and a recipient, the method comprising: grading each of a set of access mechanisms according to at least one parameter; classifying a plurality of components of the data according to a quality requirement of the access mechanism with respect to the at least one parameter; matching the class to which each of the plurality of data components belongs to the grading of the access mechanisms; and assigning a first of the plurality of data components to a first access mechanism according to the outcome of the matching; and assigning at least a second of the plurality of data components to a second access mechanism different from the first access mechanism according to the outcome of the matching.

The invention treats each component of data according to its own requirements of the parameter and assigns an access mechanism accordingly. It is then possible to match the most appropriate available access mechanism to balance quality of service against network efficiency.

The grading of the access mechanisms may be predefined. In that case the parameter may be one inherent to the access mechanism itself, such as bandwidth. However, the grading could be dynamic in the sense that the parameter is monitored while a particular access mechanism is enabled for sending data.

Typical changeable parameters include bandwidth, signal to noise ratio, signal to interference or signal to noise plus interference ratio, link delay, access mechanism occupancy, network layer capacity. Furthermore, the dynamically changing environment in which an access mechanism is used can be monitored as well. The changes may be due to environmental changes at the location of the network layer, i.e. due to changes in the environment itself, or movement of the sender or recipient within the environment.

Preferably, the classified data components are matched to the lowest acceptable quality of service from the available access mechanisms according to the parameters which are assessed in respect of the class of data. It is inefficient to take up an inappropriately high quality access mechanism with a service that requires low grade access in respect of the monitored parameter(s). To assign data components to access mechanisms according to this invention is intended to maintain system efficiency.

As a practical matter, the matching of classified data to an access mechanism will be dependent on the access mechanisms available at the time. If the most suitable access mechanism is unavailable, the method may include performing a best fit of the classified data to available access mechanisms according to the parameter which is of primary consideration, or a further parameter of a secondary consideration, in respect of a particular class of data. However, it is also preferable that the method includes the ability to deny access to a particular access mechanism by a class of data when it would be inadequately supported by any of the available access mechanisms or when the only available access mechanisms represent an inefficient use of the network to an unacceptable extent.

In one form, the invention includes a transmitter for transmitting data comprising a plurality of data components using a plurality of selected access mechanisms, the transmitter comprising: a router which is responsive to an input to assign a first of the plurality of data components to a first access mechanism to assign at least a second of the plurality of data components to a second access mechanism different from the first access mechanism; a controller arranged to derive a signal indicative of a class to which each data component belongs according to a quality requirement of the access mechanisms with respect to at least one parameter and to match the class to the set of access mechanisms which are graded according to the at least one parameter and to produce the input for the router according to the outcome of the matching.

The invention also extends to a communication network having a transmitter as referred to above.

The present invention can be put into practice in various ways, some of which will now be described by way of example with reference to the accompanying drawings in which:

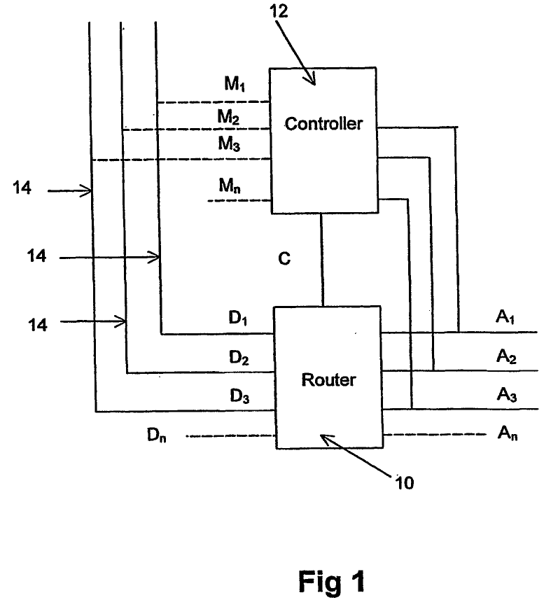

FIG. 1 is a schematic block diagram of a transmission system according to the invention;

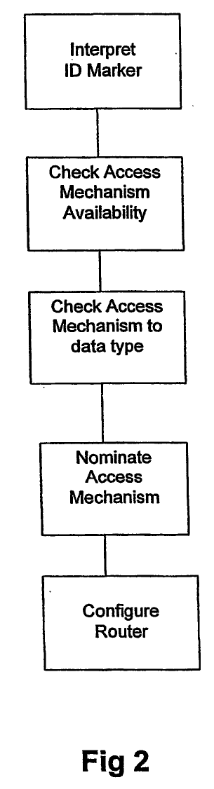

FIG. 2 is a flow diagram of the method of the invention;

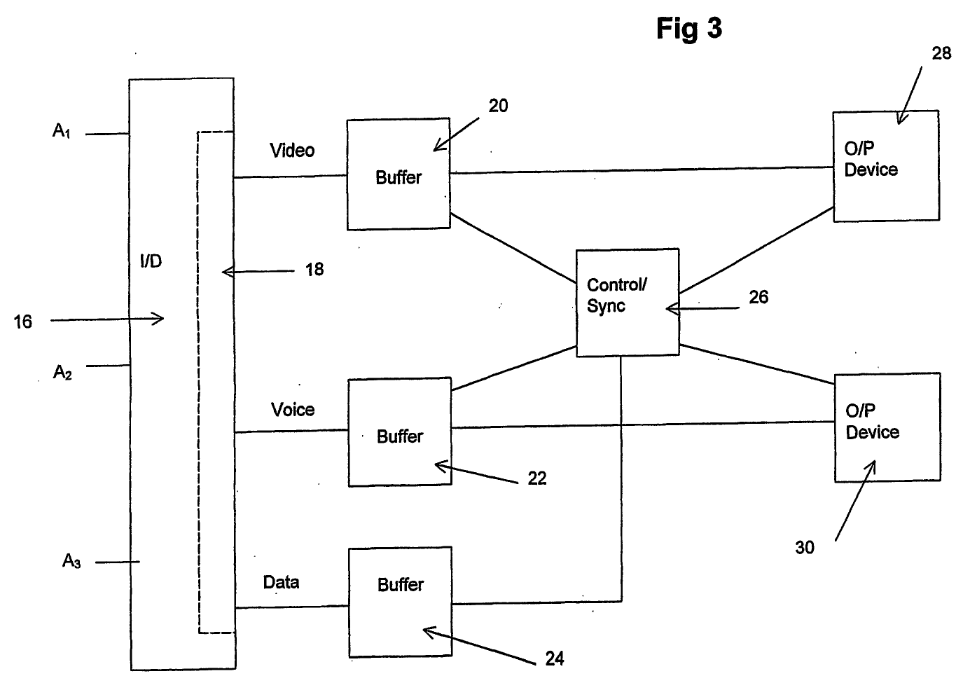

FIG. 3 is a schematic block diagram of a receiver according to the invention; and

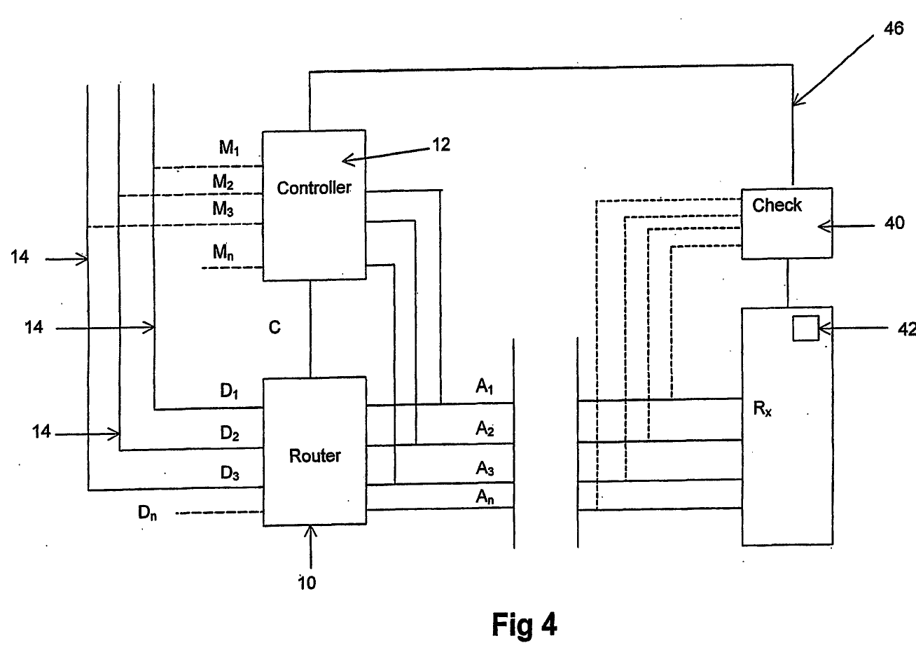

FIG. 4 is a further embodiment of a system according to the invention.

Referring to FIG. 1, a transmitter comprises a router 10 and a controller 12. In this example the system is based on the joint use of a set of air interface access mechanisms which include Second Generation (2G) techniques such as GSM and GPRS, so-called ‘2.5G’ techniques such as Enhanced Data Rates for GSM Evolution (EDGE), and Third Generation (3G) techniques such as WCDMA and TD-CDMA. Individual access techniques in this set can support a range of different types of data characteristic suitable for circuit switched and/or packet-based transmission. Incoming data for transmission comprises a plurality of data components D1, D2 . . . Dn received at the router 10 on input lines 14. The controller 12 classifies the incoming data by monitoring the data for an identification (M1, M2 . . . Mn) of the type of data on each input line 14. The identification is provided with the data in the form of an identifier signal. The router 10 is able to assign the data components to a particular access mechanism comprising an air interface, encoding scheme and/or network or transport layer in response to a command signal C from the controller 12.

The identification can be in the form of a header or field within the data stream or contained in a separate but associated channel. The signal C from the controller 12 configures the router 10 to direct the prepared data component to which the identification relates to the most appropriate access mechanism A1, A2 . . . An from the router. The access mechanisms A1-n are shown as separate lines in FIG. 1 for the purposes of illustration. The data in the various forms is actually packet or circuit switched over the network in a conventional manner. The access mechanism actually comprises the coding scheme, and associated transport layer and links nominated for a particular class of data.

By way of example, the data on line D1 may be classified by the controller 12 as video data. Thus, the most appropriate access mechanism may be wideband code division multiple access (WCDMA) for example, which is an option of the Universal Mobile Telecommunications System (UMTS), due to the requirements for low delay and high bit rate in video data transmission. Data on line D2 may be classified by the controller 12 as a voice communication requiring minimal delay, but being relatively narrow band, and can most usefully be transmitted by Global System for Mobile Communications (GSM) time division multiple access (TDMA). Text or other data may most appropriately be carried on the time division-code division multiple access (TD-CDMA) option of UMTS as it is relatively tolerant of delays, but requires high integrity transmission for reliable data recovery. The total data signal thus comprises a video component D1, an audio component D2 and a text (eg subtitles) component. Each of these components of the service have different requirements of the access mechanisms.

These are examples of the types of data and the access mechanisms available which are switched on to the network. It will be clear to the person of ordinary skill in the art that separate data streams in the same category may also be submitted for transmission simultaneously. Furthermore, more than one access mechanism of the same type may be provided. Thus, at any one time there will be a profile of data transmission requirements and a profile of available access mechanisms. When the access mechanism most suited to the data of a particular category is available, the choice is straightforward. However, in the situation in which the incoming data must be assigned to a non-optimal access mechanism, the choice has to be made on modified criteria. The basic concept in accordance with maintaining system efficiency is to choose the lowest grade access mechanism available sufficient to support the data type. Thus, the controller 12 is arranged to assign the available access mechanism next most appropriate to the data type. The priority placed on the quality of a particular parameter will be different for each class of data.

An example of a possible priority listing by data type is given in the following table. Note that the priorities shown are not meant to be definitive and may change depending on a number of issues and their relative importance (e.g. technical factors, cost factors, environment factors). Thus, the decision to assign a class of data to a particular access mechanism will be subject to the circumstances surrounding the set of access mechanisms to which the router has access.

| | 1st choice | 2nd choice | 3rd choice |
|---|---|---|---|
| | Access | Access | Access |
| Data Class | Mechanism | Mechanism | Mechanism |
| Interactive | Cable | HiperLAN | WCDMA |
| video | | | |
| Streaming | HiperLAN | TD-CDMA | GPRS |
| video | | | |
| Interactive | GSM | WCDMA | TD-CDMA |
| Voice | | | |
| Data | Wired LAN | TD-CDMA | WCDMA |

In the table ‘HiperLAN’ refers to the wireless local area network as defined by the European Technical Standards Institute (ETSI). Wired LAN is the conventional local area network arrangement.

Another parameter that can be assigned to the incoming data components is a level of urgency or priority. By further classifying the data hierarchically in this way it can be given priority access and/or be assigned to particularly low delay coding, transport layer, links, etc.

The controller 12 maintains a database of the access mechanisms and their usage. By reference to the database it is able to assign available access mechanisms based on the classification of the incoming data There will also be occasions when no access mechanism is available, or no appropriate access mechanism is available. This latter occasion may be because the available access mechanisms are unable to support the data type or the use of the available access mechanisms would constitute an unacceptable use of the network, e.g. the use of a wideband cable channel for voice communications is wasteful of network capacity. In this case, the controller is arranged to deny access to the network to that data type until a more suitable access mechanism becomes available. Note that having a set of available access mechanisms of the same type significantly reduces the probability of this case occurring.

The data type is routed by the router 10 to the appropriate encoding scheme, submitted to the appropriate access mechanism (e.g. air interface) and transmitted in a conventional manner. The sequence of steps in assigning an access mechanism and configuring the router is set out in the flow chart of FIG. 2.

FIG. 3 illustrates a receiver according to the invention. This example is an arrangement for handling multi-media data comprising video, voice/music and low bit rate messaging. The packets of data are received at an input device 16 according to access mechanisms A₁, A₂, A₃ shown here for convenience as separate data streams for the video, voice/music and messaging. The input device 16 includes a controller part 18 which identifies the access mechanism used for transmission. The data is then reassembled and decoded in conventional manner and applied to buffers 20, 22 and 24. As is conventional, the video and voice/music data blocks or packets have timing markers (t₁, t₂) which are fed to a synchroniser 26 which, if required, synchronise the video and voice/music output of the buffers 20 and 22 to output devices 28 and 30 which, in this embodiment, are a display device and sound system, respectively.

It will be appreciated that the video, voice/music and messaging received will have been supported by one access mechanism or another, as determined by the controller 12. To set up the receiver to accept data according to the elected access mechanism for each form of data, conventional mechanisms are used to establish the link between transmitter and receiver according to the normal practice for the access mechanism. By this means the appropriate protocols are established to set up the multi-media reception.

As mentioned above, consideration can be given to both inherent access mechanism parameters and those associated with the environment in which the access mechanism is used. Once an access mechanism has been elected and implemented, and a link has been established according to the availability criteria referred to above, the link quality can be monitored and on-going decisions taken on changing access mechanisms during transmission.

In this regard, FIG. 4 illustrates a further embodiment of the invention. The router 10 and the controller 12 are broadly the same as those in FIG. 1. However, at the receiver the data is continually or periodically checked by a monitoring unit 40. This is arranged to monitor the data by the use of, for example, data error checking procedures, signal to noise and/or signal to interference estimation methods. Additionally, the monitoring unit 40 is linked directly to the receiver which has a manual reject button 42 in the receiver 44. Degradation in the quality of a link is often subjective in the case of, for example, voice/music or video reception. Thus, while objective on-line data error assessment can be carried out by monitoring as described, the invention provides the facility for the receiver user to reject the quality of the incoming data or to request an enhanced quality of service. By actuating the reject button 42, an overriding access mechanism change request is sent back to the controller 12 as illustrated by line 46. The line 46 is indicative of a notional path back to the receiver, but it is not to be considered as a particular path. The actual information fed back may be transmitted via one of the available access mechanisms by which the transmitter and receiver are interlinked. The controller 12 responds by polling the available access mechanisms and substituting one for another in the event that a more appropriate access mechanism has become available since the rejected link was established. If a more appropriate access mechanism is not available, an advisory message is transmitted as text data to the receiver for display to the user.

Link degradation can be due to various phenomena. With mobile access, the opportunity for the environment to vary is greatly increased. For example, a receiver can be taken into a position in, for example, a built-up area where there is a reception shadow caused by a building. Thus, this embodiment of the invention is also able to swap between equivalent access mechanisms or between cellular network layers in response to the monitoring and feedback. As is conventional in the art, a network such as GSM (possibly running GPRS) or UMTS comprises a macrolayer for wide area network applications, microlayers typically arranged in built-up areas below roof-top to handle traffic in street canyon environments, and a picolayer for in-building local traffic. Depending on circumstances, the invention is operable to switch between layers, as constituent parts of the access mechanisms, as appropriate.

The invention is applicable to Wireless Applications Protocol (WAP) Systems, Bluetooth piconets and scatternets, and iMODE communications systems and other communications networks able to support different categories of data and different access mechanisms.

1. A method of assigning an access mechanism to data to be transmitted between a sender and a recipient, the method comprising:
grading each of a set of access mechanisms according to at least one parameter;
classifying a plurality of components of the data according to a quality requirement of the access mechanism with respect to the at least one parameter;
matching the class to which each of the plurality of data components belongs to the grading of the access mechanisms; and
assigning a first of the plurality of data components to a first access mechanism according to the outcome of the matching; and
assigning at least a second of the plurality of data components to a second access mechanism different from the first access mechanism according to the outcome of the matching.

2. A method as claimed in claim 1 in which the access mechanisms are graded according to at least one of the signal to noise ratio, signal to interference ratio, signal to noise plus interference ratio, reliability, data rate, bandwidth, delay and occupancy.

3. A method as claimed in claim 1 or 2 in which each of the set of access mechanisms includes a coding scheme, a transport layer and a communications link type.

4. A method as claimed in claim 1, 2 or 3, including denying assigning of an access mechanism when the available access mechanisms do not include one of a requisite minimum capacity or set of capacities in respect of a selected parameter or set of parameters for the class of data.

5. A method as claimed in claim 3 or 4, including denying assignment of an access mechanism when those available only consist of ones of a predetermined over capacity in respect of one or more of the parameters.

6. A method as claimed in any of claims 1 to 5, including monitoring the set of access mechanisms to determine which are available.

7. A method as claimed in claim 6 in which the at least one parameter is the degree of occupancy of each of the set of access mechanisms, the method further including monitoring each access mechanism to determine the capacity available from each access mechanism.

8. A method as claimed in claim 6 in which the at least one parameter is a quality of the access mechanism for supporting the data according to its class.

9. A method as claimed in claim 8 including monitoring the access mechanism according to the parameter.

10. A method as claimed in claim 9 including monitoring the data at a receiving end of the access mechanism.

11. A method as claimed in any of claims 6 to 10, including updating a database on the access mechanisms available to each class of data in response to the monitoring.

12. A method of transmitting data including a method of assigning an access mechanism as claimed in any of claims 1 to 11 and routing the data to one of the access mechanisms according to the outcome of the matching such that the assigned access mechanism is optimally appropriate to utilisation of the set of access mechanisms.

13. A transmitter for transmitting data comprising a plurality of data components using a plurality of selected access mechanisms, the transmitter comprising:
a router which is responsive to an input to assign a first of the plurality of data components to a first access mechanism to assign at least a second of the plurality of data components to a second access mechanism different from the first access mechanism;
a controller arranged to derive a signal indicative of a class to which each data component belongs according to a quality requirement of the access mechanisms with respect to at least one parameter and to match the class to the set of access mechanisms which are graded according to the at least one parameter and to produce the input for the router according to the outcome of the matching.

14. A transmitter according to claim 13 in which the controller is arranged to read a header within the data for deriving said signal indicative of a class which to which data belongs.

15. A transmitter according to claim 13 in which the controller is arranged to receive an input separate from the data for deriving said signal indicative of a class to which the data belongs.

16. A transmitter as claimed in claim 13, 14 or 15 in which the controller is arranged to grade the access mechanisms according to the at least one parameter selected from the group comprising signal to noise ratio, signal to interference ratio, signal to noise plus interference ratio, reliability, bandwidth, delay and occupancy.

17. A transmitter as claimed in claim 13 in which the controller comprises a database and is operable to update information in the database on the access mechanisms available to each class of data.

18. A transmitter as claimed in claim 13, 14 or 15 in which the controller is arranged to monitor the access mechanisms to feed back a signal indicative of the state of the at least one parameter.

19. A transmitter as claimed in claim 18 in which the controller is arranged to monitor the at least one parameter selected from the group comprising signal to noise ratio, signal to interference ratio, signal to noise plus interference ratio, reliability, delay and occupancy as the parameter.

20. A transmitter as claimed in any of claims 18 or 19 in which the controller is operable to update the database in response to the feedback signal from the monitoring device.

21. A communications network comprising a transmitter as claimed in any of claims 13 to 20.
